(19) United States
(12) Patent Application Publication
(10) Pub. No.: US 2005/0111406 A1
(43) Pub. Date: May 26, 2005

(54) Multi-user multicarrier allocation in a communication system

(75) Inventors: Pirjo Pasanen, Vantaa (FI); Olav Tirkkonen, Helsinki (FI); Kari Kalliojarvi, Kangasala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/757,518

(22) Filed: Jan. 15, 2004

(30) Foreign Application Priority Data
Nov. 21, 2003 (FI) 20031702

(51) Int. Cl. H04Q 7/00; H04J 1/00

(52) U.S. Cl. 370/329; 370/480

(57) ABSTRACT

In a multicarrier modulation communication system, subcarriers are allocated to a plurality of users using a plurality of sets of sequential subcarriers. The plurality of sets of sequential subcarriers may be allocated for transmitting information to the plurality of users or for transmitting information from the plurality of users. A multicarrier modulation communication system and the multicarrier modulation communications device is also discussed.

### BACKGROUND OF THE INVENTION

1. Field of the Invention

The present invention relates to allocating carrier frequencies to a plurality of users in a wireless communication system. In particular, the present invention relates to carrier frequency allocation in multicarrier modulation systems.

2. Description of the Related Art

A communication system can be seen as a facility that enables communication sessions between two or more entities such as user equipment and/or other nodes associated with the communication system. The communication may comprise, for example, communication of voice, data, multimedia and so on. Communication systems providing wireless communication for user equipment are known. An example of the wireless systems is the public land mobile network (PLMN). Another example is the wireless local area network (WLAN).

Recently intense interest has been focused on modulation techniques, which are able to provide high speed transmission over wireless channels. Multicarrier modulation techniques are promising solutions for high speed transmission over wireless channels. Multicarrier modulation is based on the idea that convolution in time domain corresponds to pointwise multiplication in frequency domain. More precisely, multicarrier modulation refers to the principle of transmitting data by dividing the data stream into several parallel bit streams and modulating each of these streams onto individual carriers or subcarriers.

In multicarrier modulation, a symbol sequence is defined in frequency domain, and the symbol sequence is then transmitted in time domain. The received samples are mapped to the frequency domain. A broad bandwidth assigned for a multicarrier modulation system is divided into narrow bandwidth carriers or subcarriers. In general, the carriers are not allowed to overlap. In a multicarrier modulation system a single user may occupy at a time the whole bandwidth, or subcarriers can be allocated between a plurality of users.

One example of multicarrier modulation is OFDM (Orthogonal Frequency Division Multiplexing). In OFDM, in contrast to general multicarrier techniques, the spectra of the carriers are allowed to overlap, under the restriction that they are all mutually orthogonal. The orthogonality of the carriers is achieved by separating the carrier frequencies by an integer multiples of the inverse of the symbol duration of the parallel bit streams. For example, suppose a system operating on a bandwidth of 100 MHz at about 5 GHz frequency. Assume further, that the maximum time delays of the signals are of the order of 2 μs, which with 100 MHz bandwidth corresponds to 200 samples. This is the length of needed guard interval between OFDM symbols. Since the guard interval should be negligible to the total number of subcarriers, the number of subcarriers can be chosen to be for example 2048, which corresponds to carrier separation of about 50 kHz. So the duration of the OFDM symbol is about 22 μs.

One of the characteristics central to any wireless communication system is multipath fading, which results in constructive and destructive interference effects being produced due to multipath signals. That is, a transmitted signal may develop a plurality of secondary signals which bounce off or are delayed by certain media, for example buildings, and result in multiple signal paths being created and received.

Allocation of subcarriers to a plurality of users in a communication system is a complex task. In multicarrier systems with frequency selective fading some subcarriers can have very poor channel gains, while other subcarriers are significantly better than the average. In multi-user systems the fades for different users are in general at different frequencies, therefore allocation of subcarriers between different users can considerably improve the spectral efficiency and performance of the system.

When the number of subcarriers is large, finding an optimal allocation between several users becomes computationally very complex and time consuming. In addition, the amount of overhead signaling needed to transmit the information about the allocation of subcarriers to each user may become substantial. The overhead may become so large that is eats up the spectral efficiency gains obtained by multi-user diversity. Also, when subcarriers are allocated to different users practical difficulties arise, especially in the uplink transmission. The receiving base station needs to be able to deal with different frequency offsets and huge dynamic ranges of the users' signals, which is a very difficult problem. The frequency offset might be solved by leaving a sufficient number of unused subcarriers between the carriers allocated to different users to act as a guard band. The width of the guard band depends on users' offsets and can be significant for users moving at high velocities.

For a multi-user OFDM system, a resource allocation algorithm has been proposed by C. Y. Wong, R. S. Cheng, K. B. Letaief and R. D. Murch in “Multiuser subcarrier allocation for OFDM transmission using adaptive modulation”, Proc. IEEE VTC Spring, July 1999, vol. 1, pp. 479-483. This resource allocation algorithm tries to minimize the total transmit power in a multi-user OFDM system by using combined bit, power and subcarrier allocation subjected to rate requirements for each user.

Multicarrier modulation can be combined with multiple transmitting and receiving antennas, that is with MIMO (Multiple Input Multiple Output) systems. Bit, power and subcarrier allocation for single-user OFDM systems in MIMO context has been discussed by K.-K. Wong, R. S.-K. Cheng, K. B. Letaief and R. D. Murch, in “Adaptive Antennas at the Mobile and Base Stations in an OFDM/TDMA System”, Proc. IEEE Transactions on Communications, January 2001, vol. 49, pp. 195-206. The attempt was to maximize the signal to interference plus noise (SINR) of the single user by adjusting the receive and transmit antenna weights, given the transmitter power constraint. Reduction of the computation complexity of the single user system was achieved by assuming that the weights for sequential subcarriers can be assumed to be equal, depending on the channel coherence bandwidth. Multi-user aspects were discussed briefly in the context of assuring the stability of multi-user weight adjusting procedure to maximize the minimum SINRs of the users.

All known multi-user allocation methods for multicarrier modulation systems allocate individual subcarriers to users. The operation of these systems can be described by means of the following example. Consider a system with N users and K subcarriers, with individual rate constraints for each user. The number of possible configurations from which an optimal configuration should be found can be calculated by first finding all possible partitions κ=(k₁, k₂, . . . , k_{N}), Σᵢ^{N} kᵢ=K of K into N parts kᵢ, and then calculating all the possible ways of choosing the subcarriers for each κ. Here it is assumed that the subcarriers are not necessarily divided equally between the users.

For example, consider the above discussed example of an OFDM system, where a 100 MHz bandwidth is divided into 2048 subcarriers of 50 kHz each. It is clear that finding an optimal solution among all the possible configurations κ is not practical. Instead sub-optimal iterative solutions need to be used. It should be noted that with the number of subcarriers of the order of 2048, even suboptimal iterative methods, which allocate subcarriers individually, become cumbersome.

Furthermore, the users need to know which subcarriers they use. With a large number of subcarriers allocated individually to the users, the number of bits required to transmit this information will grow too large to be feasible to transmit.

One of the aims of the present invention is provide a feasible solution to the problem of multiuser subcarrier allocation.

### SUMMARY OF THE INVENTION

A first aspect of the invention provides a method of allocating subcarriers in a multicarrier modulation communication system, the method comprising allocating a plurality of sets of sequential subcarriers to a plurality of users.

A second aspect of the invention provides a network element for controlling multicarrier modulation communications, the network element being configured to allocate a plurality of sets of sequential subcarriers to a plurality of users in an allocation period.

A third aspect of the invention provides a multicarrier modulation communication system, the multicarrier modulation communication system being configured to allocate a plurality of sets of sequential subcarriers to a plurality of users in an allocation period.

A fourth aspect of the invention provides a method of multicarrier modulation transmission, comprising transmitting at least one signal relating to at least one set of sequential subcarriers among a plurality of sets of sequential subcarriers allocated in an allocation period to a plurality of users.

A fifth aspect of the invention provides a method of multicarrier modulation reception, comprising receiving at least one signal relating to at least one set of sequential subcarriers among a plurality of sets of sequential subcarriers allocated to a plurality of users in an allocation period.

A sixth aspect of the invention provides a device for multicarrier modulation transmission, the device being configured to transmit at least one signal relating to at least one set of sequential subcarriers among a plurality of sets of sequential subcarriers allocated to the plurality of users in an allocation period.

A seventh aspect of the invention provides a device for multicarrier modulation reception, the device being configured to receive at least one signal relating to at least one set of sequential subcarriers among a plurality of sets of sequential subcarriers allocated to a plurality of users in an allocation period.

The plurality of sets of sequential subcarriers may be allocated for transmitting information to the plurality of users or, in other words, for receiving information in the plurality of users. The plurality of sets of sequential subcarriers may, alternatively, be allocated for transmitting information from the plurality of users or, in other words, for receiving information from the plurality of users.

The size of a set of sequential subcarriers may be determined, for example, by taking into account the channel cohererence bandwidth of at least one of the users. More particularly, the smallest channel coherence bandwidth of the plurality of users may be taken into account, or the size of each set of sequential subcarriers may be determined by taking into account the channel coherence bandwidth of the respective user.

A modulation or coding scheme or channel properties of at least one of the plurality of users may be taken into account in determining the size of a set of sequential subcarriers.

There may be defined a lower limit for the size of the set of sequential subcarriers. The lower limit may be a cell-specific lower limit or a system specific lower limit. If the lower limit is a system-specific lower limit, there may be a further cell-specific lower limit for the size of the set of sequential subcarriers.

There may be provided at least one unallocated guard band between two of the plurality of sets of sequential subcarriers allocated to the plurality of users.

The size of a set of sequential subcarriers may be selected from a plurality of predetermined sizes. A size of a set of sequential subcarriers may be a power of two. The block length of a space-frequency code used for at least one of the plurality of users may be taken into account in selecting the size of a set of sequential subcarriers. The length of a coding block for at least one of the plurality of users may be a multiple of the size of a set of sequential subcarriers.

Within an allocation period each set of sequential subcarriers may be of the same size, or there may be at least two sets of different sizes.

The channel properties of the users may be taken into account in allocating sets of sequential subcarriers to the users. The embodiments of the invention provide advantages of improved spectral efficiency and throughput of a multiuser multicarrier modulation system, while keeping the computational complexity of the subcarrier allocation reasonable. The complexity can be significantly reduced from that relating to allocation subcarriers individually by allocating subcarriers using sets of sequential subcarriers. In some embodiments of the invention, the numbers of subcarriers in the sets depend on the channel coherence bandwidth of users.

The embodiments of the invention are applicable for allocating subcarriers for transmitting signals from a plurality of users. In this case the subcarriers are allocated to the plurality of users for transmission, and each user employs in the transmission the subcarriers allocated to that specific user. The signals may be received by one or more than one user. Each user device may have one or more than one transmitter or receiver.

Alternatively or additionally, the embodiments of the invention are applicable for allocating subcarriers for transmitting signals to a plurality of users. In this case the subcarriers are allocated to the plurality of users for reception, and one or more than one transmitting user employs the subcarrier allocation in transmitting signals to the plurality of users.

### BRIEF DESCRIPTION OF THE DRAWINGS

Embodiments of the present invention will now be described by way of example only with reference to the accompanying drawings, in which:

FIG. 1 shows schematically a communication system with which embodiments of the invention can be used;

FIG. 2 shows schematically a MIMO system with which embodiments of the invention can be used;

FIG. 3 shows a flowchart of a method in accordance with an embodiment of the invention,

FIG. 4 shows schematically the allocation of subcarriers in sets of subsequent subcarriers;

FIG. 5 shows schematically one possible allocation of sets of subsequent subcarriers; and

FIG. 6 shows simulation results of four methods in accordance with embodiments of the invention together with simulation results of three reference subcarrier allocation methods.

### DETAILED DESCRIPTION OF THE PREFERRED EMBODIMENTS

In the following description, reference is often made to OFDM multicarrier modulation system. It is, however, appreciated that the invention is applicable to any multicarrier modulation system.

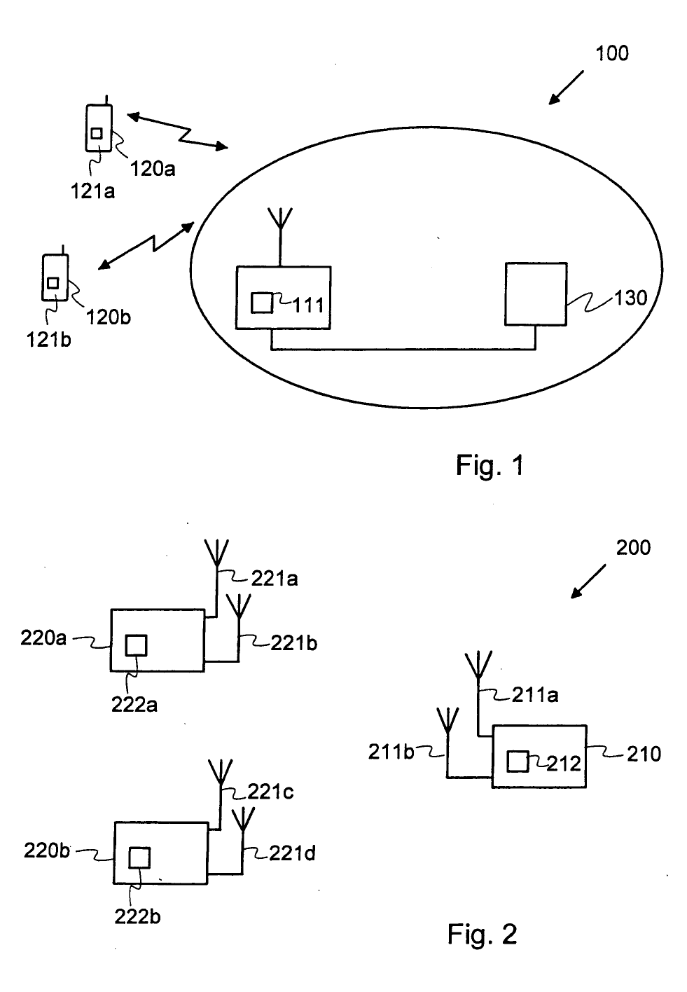

FIG. 1 shows schematically, as an example, a part of a communication system 100 with which embodiments of the invention can be used. The multicarrier modulation transmitting device 110 may be, for example, a base station of a cellular communication system or a network element of any wireless communication system. The multicarrier modulation transmitting device 110 may have one transmitter antenna or, a plurality of transmitter antennas. Similarly, the multicarrier modulation transmitting device 110 may have one or more than one transmitters. The user equipment 120 may be a terminal capable of communicating with the cellular communication system or with any other wireless communication system. The user equipment 120 illustrated in FIG. 1 has one receiving antenna, but in general it is possible that a user equipment has more than one receiving antenna. The user equipment may have one or more than one receivers. The invention is applicable in any device, which employ multicarrier modulation. If the invention is applied in a cellular communications system, the allocation of subcarriers typically takes place in a control network element 130 responsible for the control of the radio resources.

FIG. 2 shows schematically a simple MIMO (multiple input, multiple output) system 200 with which embodiments of the invention can be used. A MIMO system is a system, which consists of multiple transmitting antennas and multiple receiving antennas. The benefit of a MIMO system is that by combining the data is certain ways at the transmitting end and at the receiving end, the overall quality (bit error rate BER) or the throughput capacity (bit rate) of the system can be improved.

The MIMO system 200 comprises a multicarrier modulation transmitting device 210 and, by the way of an example, two receiving devices 220. The multicarrier modulation transmitting device 210 comprises a plurality of transmission antennas 211, and each receiving device 220 comprises a plurality of receiving antennas 221.

FIGS. 1 and 2 refer to a situation, where subcarriers are allocated to a plurality of users for transmission. Each transmitting users sends information using the subcarriers allocated to that specific user. Alternatively, the subcarriers may be allocated to a plurality of users for reception. In a cellular communication system, for example, the invention is applicable in the downlink direction (from a base station to user equipment) and/or in the uplink direction (from user equipment to a base station).

For selecting suitable subcarriers for users in a SISO (single input, single output) system or in a MIMO system, the channel responses of the users typically need to be known. For a SISO channel, the multicarrier channel model is
yₖ=hₖ·xₖ+nₖ
where k is the index for subcarriers, x is the vector of sent symbols, y is the vector is received symbols, hₖ is the channel response of subcarrier k, and n represents noise. In multicarrier modulation MIMO system, each subcarrier has a plurality of spatical MIMO channels. For a MIMO channel, the multicarrier channel model is
yₖ^{a}=Hₖ^{a,b}·xₖ^{b}+nₖ^{a}
where a is index for receiver antennas (a=1, . . . , Nᵣ), b is index for transmitter antennas (a=1, . . . , Nₜ), xₖ and yₖ are vectors and Hₖ is a Nᵣ×Nₜ matrix. For subcarrier allocation, information is usually needed about the channel response hₖ for a SISO system and about the channel response matrix Hₖ^{a,b} for a MIMO system.

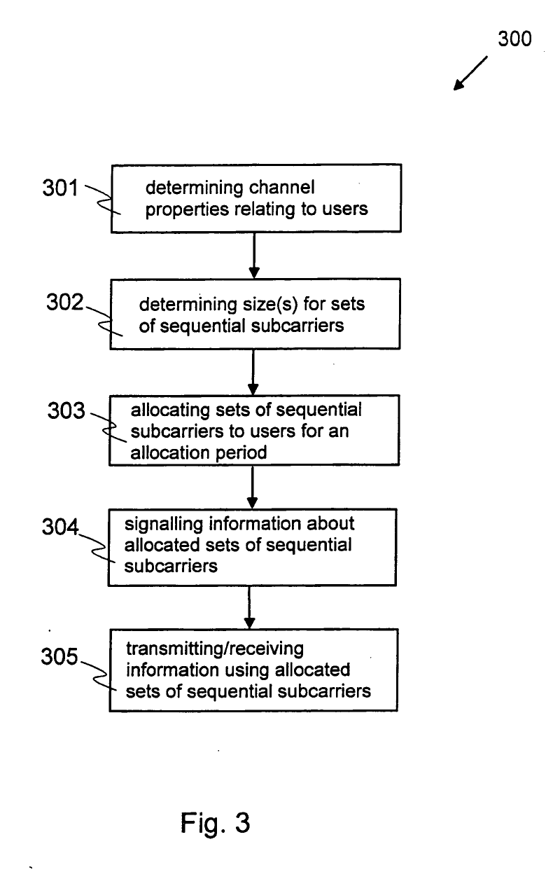

FIG. 3 shows a flowchart of a method 300 in accordance of an embodiment of the invention. In step 301, channel properties relating to users are determined. In step 302, sizes for sets of sequential subcarriers are determined. Determining set sizes is discussed in more detail below. In step 303, sets of sequential subcarriers are allocated to users. In step 304, information indicating allocation of sets of sequential subcarriers is signaled to the users. Some specific examples of signaling allocation information are discussed below. In step 305, information is transmitted and received using the allocated sets of sequential subcarriers.

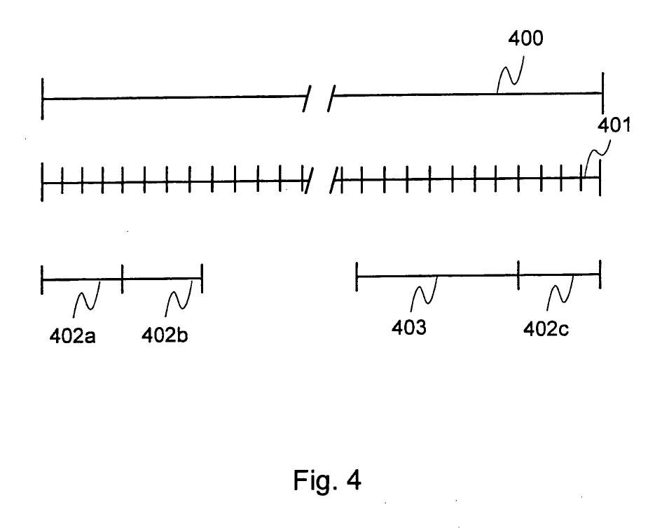

FIG. 4 shows schematically the allocation of subcarriers in sets of subsequent subcarriers. The bandwidth available for the multicarrier modulation system is illustrated with line 400. In a multicarrier modulation system, the bandwidth is typically divided in subcarriers 401, which have equal widths. The subcarriers are usually thus determined on a system level. For example, in a system the bandwidth available for OFDM may be 100 MHz, and this bandwidth may be divided into 2048 subcarriers each having about 50 kHz bandwidth. As illustrated in FIG. 4, the subcarriers may be grouped into sets 402, 403 of subsequent subcarriers. The sets may all have the same width or, as FIG. 4 shows by the way of an example, the sets may have different widths. In FIG. 4, sets 402a, 402b and 402c have a first width, as in FIG. 4 each of sets 402a, 402b and 402c contains 4 subcarriers. Set 403, on the other hand, has a broader width, and it contains 8 subcarriers. In cellular communication systems, the sets are typically determined on a cell level. Grouping of subcarriers into sets of sequential subcarriers may thus vary from cell to cell in a cellular communication system.

The sizes of the sets are typically determined by taking the channel coherence bandwidths of the users into account. The spectral efficiency and the throughput of the system do not suffer significantly from allocating subcarriers in sets of sequential subcarriers instead of allocating subcarriers independently, if the number of subcarriers in a set is determined so that the channel quality will not change much at that frequency interval. The number of subcarriers in a set is may either be fixed or it may vary from set to set. If the set size varies, the size of a set is typically determined to be of the order of the coherence bandwidth of the user's channel, or a fraction of the channel coherence bandwidth. The channel coherence bandwidth is approximately given by the inverse of the multipath spread Tₘₚ of the channel, W_{coh}=1/Tₘₚ. The multipath spread of the channel may be estimated, for example, as the maximum time delay in a tapped delay line signal model. The size of the set can be varied as the user's channel changes.

It is appreciated that in some embodiments of the invention, multicarrier modulation transmission may employ a fixed size for the sets for an allocation period. In this case, the size of the sets is typically of the order of the smallest coherence bandwidth of the users' channels, or a fraction of this channel coherence bandwidth. Term users here refers to those users for whom information is sent using the multicarrier modulation bandwidth or to users, who are sending information using the multicarrier modulation bandwidth.

The channel coherence bandwidth can be determined based on signals sent from the receiver to the transmitter. For determining the channel coherence bandwidth, the signals from the receiver need not be sent on the same frequency as the transmitter is using for the multicarrier modulation transmission.

For reducing the complexity of the system, it is appreciated that it is possible to set one or more lower limits to the size of a set of sequential subcarriers. For example, in a cellular communications system, there may be a system-specific lower limit and/or a cell-specific lower limit. The system-specific lower limit for the size may be used to avoid, for example, very small set sizes whose allocation to multiple users requires extensive signaling, or they may be determined by the coding and modulation schemes used. In addition, in some embodiments of the invention it may be advantageous to leave guard bands (e.g. unused subcarriers) between the sets of sequential subcarriers allocated to different users. This happens e.g. when scheduling uplink transmissions. These guard bands affect the selection of a system specific lower limit; very small set sizes render the use of resources inefficient since the proportion of unused guard bands becomes large. The cell-specific lower limits, on the other hand, may be used to take into account information about the surroundings of the multicarrier modulation transmitter. If the size of the set of sequential subcarriers, determined using a channel coherence bandwidth, is larger than the system-specific or cell-specific lower limit, then the set size determined using a user channel coherence bandwidth may be used.

It is appreciated that in some cases the channel coherence bandwidth of a user may be so small that it is advisable to allocate the multicarrier modulation bandwidth to users using other resource allocation methods. For example, the multicarrier modulation bandwidth may be treated as a bandwidth for a single user and then the whole bandwidth or suitable subcarriers within the multicarrier modulation bandwidth may be allocated to different users is sequential frames. Alternatively, the multicarrier modulation bandwidth may be allocated in an allocation period to more than one user, but using an allocation method different from the one presented in this description. It is noted that a specific threshold value may be set, which the channel coherence bandwidth should exceed for allocation multicarrier modulation bandwidth to multiple users in sets of sequential subcarriers. This specific threshold may be set in addition to system and/or cell-specific lower limits for the set size.

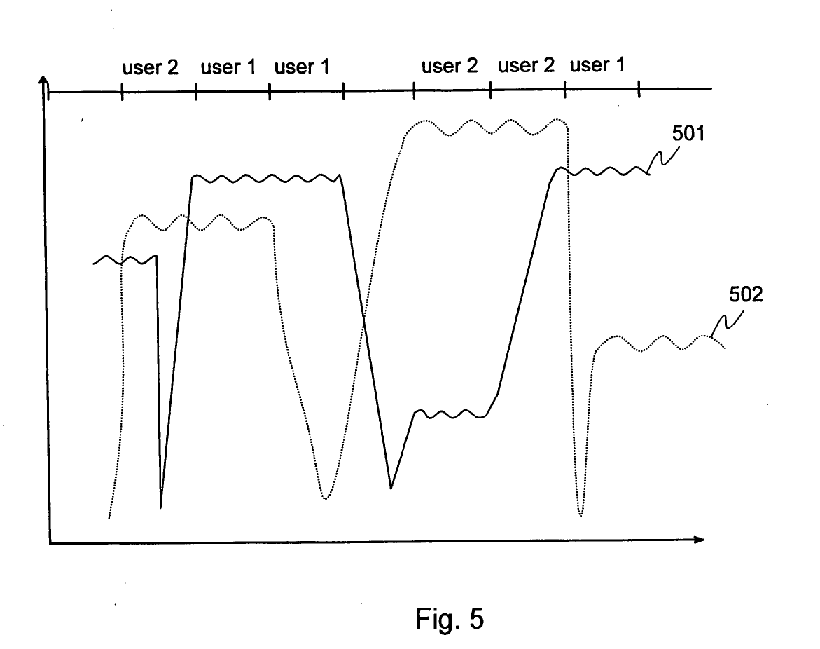

FIG. 5 shows schematically one possible allocation of sets of subsequent subcarriers. The lower part of FIG. 5 illustrates, as examples, the channel responses as functions of frequency of two users: the channel response of user 1 is shown with a solid line 501 and the channel response of user 2 is shown with a dashed line 502. As can be seen, the frequencies at which there is significant amount of fading—i.e. where the frequency responses are small—occur at different frequencies for the different users. The upper part of FIG. 5 illustrates the division of the multicarrier modulation bandwidth into sets of sequential subcarriers, the sets being of equal size in FIG. 5 by the way of example. Furthermore, the upper part of FIG. 5 illustrates the allocation of two of the sets to user 1 and two of the sets to user 2. It is appreciated that the number of sets to be allocated for each user may vary from user to user and also from allocation period to allocation period.

FIG. 5 illustrates also an advantage of multiuser diversity. When the whole multicarrier modulation bandwidth is allocated for the use of a single user, it typically is possible to use effectively the frequencies, where multipath fading occurs, only by allocating large transmission powers and/or low bit rates to those frequencies. As the frequencies, where multipath fading occurs, usually are different for different users, it is possible to allocate frequencies, where the frequency response of user 1 is poor, to user 2 and vice versa. This improves spectral efficiency and system throughput.

For allocating sets of sequential subcarriers to users efficiently, there is need for obtaining information about relevant channel properties of the users. The relevant channel properties are often determined by channel responses of the users. As mentioned above, information is usually needed about the channel response hₖ for a SISO system and about the channel response matrix Hₖ^{a,b} for a MIMO system. A channel quality indicator (CQI) defined by a suitable metric may be used for subcarrier allocation. For a SISO channel, a suitable channel quality indicator may be, for example, the signal to noise ratio, or the signal to noise plus interference ratio. A suitable metric, for example, for MIMO spatial multiplexing channels may be more complex to determine than for SISO channels. It is appreciated that a person skilled in the art of MIMO transmitters will be familiar in determining a suitable metric for MIMO spatial multiplexing channels. For example, the determinant of the squared channel matrix det(H^{H} H), the total channel power tr(H^{H} H), or a capacity related measure log det(1+ρH^{H} H) may be used, where ρ is the signal to noise ratio. The CQI related to a set of sequential subcarriers may be calculated from one subcarrier in the set only, preferably from a subcarrier close to the middle of the set. Alternatively, the CQI for the set may be calculated from the corresponding CQIs of multiple subcarriers in the set, as for example the average, minimum or maximum of the first and last subcarrier, or ultimately of all subcarriers in the set. The CQI may be based on the most recent channel measurement, or it may be a sliding average over a few most recent measurements. A sliding average is less susceptible to channel estimation errors. The window of the sliding average should be within the channel coherence time. The sliding average may be enhanced by weighting, so that more recent measurements are given more weight than older ones.

If a cellular communication system employs Time Division Duplex (TDD), signals are typically sent in the downlink and in the uplink direction using a same frequency. The same is true for any communication link between two transceivers. If TDD is used, then communications between the two transceivers occur in both directions at a same frequency or at same frequencies. In TDD systems, it is therefore straightforward to obtain channel responses or other channel properties of users using the signals received from the multiple users. In Frequency Division Duplex (FDD) systems reception and transmission of information occurs at different frequencies. It may be possible to estimate channel responses or other channel properties from signals received at different frequencies, but typically in FDD systems information about the channel responses needs to be sent as feedback information from the receiving users to the transmitting user for obtaining reliable channel information. Such feedback information may thus be needed for allocating multicarrier modulation bandwidth for the transmissions directed to the users from the multicarrier modulation transmitter.

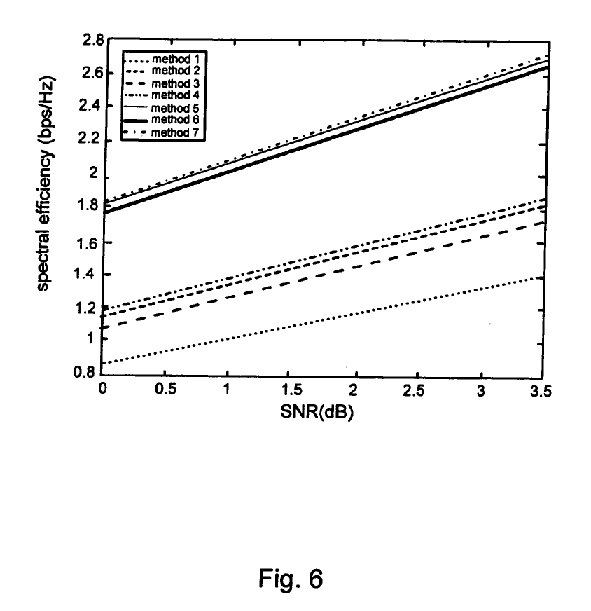

FIG. 6 shows simulation results of four methods in accordance with some embodiments of the invention together with simulation results of three reference subcarrier allocation methods. The simulation results are spectral efficiencies in bps/Hz (bits per second per Hz) as functions of signal to noise ratio (SNR) in dB. In the simulations, an OFDM system having a multicarrier modulation bandwidth of 100 Mhz divided into 2048 subcarriers has been studied. The channel model is a time-delayed tap model with each tap obeying flat Rayleigh fading statistics. The simulated situation is N=8 users in a cell. For simplicity, the average gain of a channel is assumed to be equal for all users. This means that no path loss or shadowing due to positions of the users inside a cell is taken into account.

Time delays and powers are taken from ITU (International Telecommunication Union) models, and an additional random element is added to the time delays for each user to create variance in the channel profiles of the users. The average maximum time delay for each user is about 41·10⁻⁸ s. This translates into an average coherence bandwidth of 2,4 MHz which compared to the subcarrier bandwidth of 49 kHz is quite large.

For each sample a channel realization, with randomized delays, is created for each user in the simulation. Several different subcarrier allocation methods are performed between the users, and resulting total system capacities are calculated. The capacity results are then averaged over all samples.

To concentrate on the system level effect of subcarrier allocation and to simplify the simulations, only allocation methods with fixed bit loading and power allocation and fixed modulation for each subcarrier are considered. If the power and bits were allocated optimally to each subcarrier, or even according to some suboptimal methods, the spectral efficiencies would of course be much higher. However, this does not have significant effects in the comparison between allocation of individual subcarriers and allocation of sets of sequential subcarriers.

In the simulation, for methods in accordance with embodiments of the invention the number of subcarriers in a set is determined for each channel realization by
d=2^{└log}^{₂}^{(FN}^{_{carryiers}}^{W}^{_{coh}}^{/W)┘}
where W_{coh} is the smallest coherence bandwidth of users for a sample, W is the multicarrier modulation bandwidth, N_{carriers} is the total number of subcarriers and F indicates the fraction of coherence bandwidth. └•┘ denotes the integer part. The restriction of the size of the sets to powers of two is done to simplify the allocation routines. It also serves to reduce the amount of signaling; see below further discussion on signaling needs. In the simulations, W=100 MHz and N_{carriers}=2048. The number of subcarriers in a set d varies from a sample to sample and from allocation method to method.

In the first reference allocation method, which is indicated in FIG. 6 as “method 1” and whose results are shown in FIG. 6 with a dotted line, the multicarrier modulation bandwidth is divided into N equal parts, one for each user. In other words, the subcarriers are grouped into 8 sets, each having 256 subcarriers. With the channel models used in the simulation, this first reference allocation method (method 1) is effectively the same as allocating to one user all the subcarriers at a time. This means that this first reference allocation method provides no system gain from multiuser diversity. The simulation results of method 1 in FIG. 6 serve only as a reference for indicating multiuser frequency allocation gains of the other methods.

As an example of allocation of subcarriers to different users, a first embodiment of the invention employs fair allocation of subcarriers. In the first embodiment of the invention, the sets of sequential subcarriers are allocated to each user in turn. For each user, the available set with the best channel response is selected. The channel response may be measured in a predetermined frequency of a set. In the simulations, the channel response is measured at the lowest subcarrier of a set. The channel response may be alternatively measured, for example, at the center-most subcarrier of a set or at the highest subcarrier of a set.

The methods, which are indicated in FIG. 6 as “method 2” and “method 3”, are methods according to the first embodiment of the invention. In methods 2 and 3, the multicarrier modulation bandwidth is divided into sets of sequential subcarriers, the size of the set being of the form 2^{p}.

For method 2 in FIG. 6, the size of a set of sequential subcarriers for a sample in the simulation is determined by the above formula for d with F=½. This means that the size of a set is about half of the smallest coherence bandwidth of the N users. For method 3 in FIG. 6, F=1 and the size of a set is about the smallest coherence bandwidth of the N users. The simulation results of method 2 are marked with a thin dashed line and the simulation results of method 3 are marked with a thick dashed line.

The second reference allocation method is “method 4” in FIG. 6. In this method, subcarriers are allocated individually to the N users and a subcarrier is allocated for each user in turn. Method 4 is thus an allocation method in accordance with the prior art discussed above. The simulation results of method 4 are indicated in FIG. 6 with a thick dashed and dotted line.

In the simulation of methods 2, 3 and 4 all users will be allocated the same number of subcarriers, and all subcarriers are allocated. This means that the users are allocated the same number of bits, as the bit loading and modulation is not adaptive. In reality users may have different rate requirements, but for simplicity it was assumed the allocation within one time slot is done only among users with equal rate requirements and approximately equal channel gains. Methods 2, 3 and 4 are fair allocation methods in that sense that they quarantee a minimum bit rate for each user, as a subcarrier (method 4) or a set of sequential subcarriers (methods 2 and 3) are allocated to each user in turn.

By comparing the simulation results of the methods 2 and 3 to the results of the two reference methods 1 and 4, it can be seen that the methods 2 and 3 in accordance with the first embodiment of the invention provide better spectral efficiency than method 1. Furthermore, the simplified subcarrier allocation, where subcarriers are grouped into sets of sequential subcarriers, provides nearly as good spectral efficiency as method 4, where the subcarriers are allocated individually to the users. The simulation results of methods 2 and 3 thus show that allocation of subcarriers in sets of sequential subcarriers, instead of allocating subcarriers individually, does not significantly worsen the spectral efficiency of the system. The subcarrier allocation, however, is far less complex for methods 2 and 3 than for the reference method 4.

As can be seen in FIG. 6, the difference in spectral efficiency is at most 0.1 bps/Hz for methods 2 and 3 with respect to the reference method 4. Even when the size of the set of sequential subcarriers is determined to be about twice the smallest channel coherence bandwidth (that is, F=2), the difference in the spectral efficiency is only about 0.2 bps/Hz. FIG. 6 shows no simulation results for this case. It is furthermore noted that the losses would be even smaller if the gain due to simplified signaling would be taken into account.

In allocation methods, where each user in turn is allocated subcarriers, a user may indicate, which subcarrier set or sets it would like to have. Alternatively, the system may decide on the allocation without input from users or without paying attention to any user indication about desired subcarrier set(s).

In the first embodiment a higher level scheduling method that is fair is used, as each user is offered a certain transmission capacity. It is evident that a fair scheduling may additionally take into account the information transmission or reception need of users, not just provide same information transmission or reception capacity to all users.

As a further example of higher level scheduling methods applicable with the idea of allocating subcarriers in sets of sequential subcarriers, a second embodiment of the invention employs opportunistic scheduling. In the second embodiment of the invention, each set of sequential subcarriers is allocated to the user having the best channel response within the set. This opportunistic subcarrier allocation is thus indifferent to any needs of the users for information transmission or receipt. The channel response may be measured in a predetermined frequency of a set or the best channel response may be defined as the maximum channel response within the set. In the simulations, the latter option is used.

The methods indicated in FIG. 6 as “method 5” and “method 6” are methods in accordance with the second embodiment of the invention. In methods 5 and 6, the multicarrier modulation bandwidth is divided into a sets of sequential subcarriers, the size of the set being of the form 2^{p}. This is similar to the above discussed methods indicated as methods 2 and 3 in FIG. 6.

For method 5 in FIG. 6, the size of a set of sequential subcarriers for a sample in the simulation is determined by the above formula for d with F=½. This means that the size of a set is about half of the smallest coherence bandwidth of the N users. For method 6 in FIG. 6, F=1 and the size of a set is about the smallest coherence bandwidth of the N users. The simulation results of method 5 are marked with a thin solid line and the simulation results of method 6 are marked with a thick solid line in FIG. 6.

The third reference allocation method is “method 7” in FIG. 6. In this method, subcarriers are allocated individually to the N users and each subcarrier is allocated to the user having the best channel response at the subcarrier frequency. Method 7 is thus an allocation method in accordance with the prior art discussed above. The simulation results of method 7 are indicated in FIG. 6 with a thin dashed and dotted line.

Methods 5, 6 and 7 are opportunistic allocation methods, which do not guarantee a minimum bit rate for each user. From the system point of view the capacity optimal method is one which chooses the user with the best channel response for each subcarrier, without any requirements for equal service for all users. The simulation results in FIG. 6 indicate clearly that the spectral efficiency of a system is better, when a opportunistic allocation method (methods 5-7) is used than when a fair allocation method (methods 2-4) is used.

The simulation results also indicate that the difference in spectral efficiency between the simplified allocation methods 5 and 6, where subcarriers are allocated in sets of sequential subcarriers, and method 7, where subcarriers are allocated individually, is almost non-existent. Again, losses would be even smaller if the gain due to simplified signaling is taken into account. This means that also for the studied opportunistic allocation methods, allocation of subcarriers in sets of sequential subcarriers does not significantly worsen the spectral efficiency when compared to individually allocating subcarriers. Furthermore, adaptive modulation, bit loading and power allocation would further enhance the system efficiency.

The allocation of subcarriers in sets of sequential subcarriers can be used with any multicarrier resource allocation methods. Methods 2, 3, 5 and 6 are discussed above as examples of fair and opportunistic allocation methods in accordance with embodiments of the invention. The simulation results in FIG. 6 seem to indicate that irrespective of the higher level scheduling algorithm, allocation of sets of sequential subcarriers should not worsen the spectral efficiency of a system when compared to allocation of subcarriers individually.

In addition to the above examples of fair and opportunistic allocation methods any type of higher level scheduling algorithm, which is designed to divide resources between multiple users by taking into account their channel quality, rate, BER, delay, priority or other such requirements, can be used together with allocating subcarriers in sets of sequential subcarriers. It is possible, for example, to group the users into user groups. The user groups may be determined, for example, based on an instantaneous transmit power of a user, on a priority of a user, or on a priority of a connection to which the data to be transmitted belongs. The subcarriers are allocated to the user groups in turn. Within each user group, the subcarriers may be allocated in sets using, for example, an opportunistic allocation method. The spectral efficiency of allocation methods, where within user groups a opportunistic allocation method is used, is typically better than that of fair allocation methods, but less than that of opportunistic allocation methods.

In some embodiments of the invention, a set of sequential subcarriers within unallocated subcarriers is allocated to a user, whose channel response is not known to the system. Such a user may be, for example, a new user arriving to a cell of a communication system. This means that allocation of subcarriers to a further user does not require re-allocation of the already allocated subcarriers. Furthermore, information about the subcarriers allocated to the new user need not be told to the previous users. Also a further set of sequential subcarriers to a specific user may be allocated within unallocated subcarriers. Alternatively, the subcarriers may be re-allocated among the users using any specified allocation algorithms.

A user needs to receive information about the subcarriers which have been allocated to the user. Already the allocation of subcarriers in sets of sequential subcarriers reduces the amount of signaling information needed for indicating the subcarrier allocation. For reducing the signaling needs further, the size of a set of sequential subcarriers may be selected from certain predetermined sizes. In some embodiments of the invention, the size may be fixed to be of the form 2^{p}. In a system with multiple transmit antennas (MISO or MIMO), space-frequency block codes, or space-frequency matrix modulation is often used. These are transmissions from the multiple antennas that extend over multiple frequency subcarriers. The number of subcarriers is called the block length of the space-frequency block code. Matrix modulations have been extensively discussed in the book A. Hottinen, O. Tirkkonen, R. Wichman, “Multiantenna transceiver techniques for 3G and beyond,” Wiley 2003. If space-frequency matrix modulation is used, it is preferable that the number of subcarriers in a set is an integer multiple of the block length of the space-frequency matrix modulation, plus possible subcarriers reserved for pilot symbols. It is furthermore appreciated that the coding and/or modulation scheme may be taken into account in determining the size of a set of sequential subcarriers also in other ways, not only by selecting one of predetermined sizes for a set of sequential subcarriers.

As examples of allocation information to be signaled, consider the following. When the set size is fixed and the subcarrier division is known to the users, there is need to signal only the set size and the index of a set to a user. A user can determine the subcarriers allocated for the user based on this information. Or alternatively it is possible to signal the fixed set size and user indexes for each set. The set size can vary from one allocation period to a next allocation period.

As an example of the reduced signaling needs, the following example is considered. If 2048 subcarriers are allocated individually for N users, log₂(N)·2048 bits are needed to transmit the allocation information. For N=8, this means 6144 bits, which is an infeasible amount of signaling information. If a fixed set size d is used, the number of bits needed to transmit the allocation information is reduced roughly by factor d. Some bits are needed to transmit information about the fixed size. With the fixed size being d=2^{p} and the number of subcarriers being 2048 the signaling need is log₂(N)·2^{11-p}+└log₂p┘ bits. For N=8 and p=5, this means 194 bits. In practice the need for signaling can be even less, if the channels and the user needs for data transmission vary slowly in time and the allocation information is transmitted only when subcarrier allocation changes.

Allocating subcarriers to different users in sets of sequential subcarriers can also help to alleviate the problems arising from different frequency offsets of the users. Detection of several users' signal with different offsets cannot be done if the frequencies will overlap. Therefore guard bands between different users' subcarriers will be needed especially in the uplink transmission to ensure that no overlap will appear. When allocation is done in sets of sequential subcarriers instead of individual subcarriers fewer guard bands will be needed.

In principle, the coherence time defines how often allocation of subcarriers should be done. In other words, the coherence time defines in principle the duration of an allocation period. As the coherence time is typically different for different users, it is possible to re-allocate subcarriers to only some of the users, while maintaining the allocation of subcarriers to the rest of the users. Alternatively, if the allocation period is of a fixed duration, for example a system frame, it is possible to allocate subcarriers to all users within each allocation period.

As an example, consider a system with a carrier frequency of 5 GHz corresponding to a wavelength of about 6 cm. For a user, whose velocity is 3 km/h, the coherence time is thus about 36 ms, the symbol duration is determined by the inverse of subcarrier separation: 1/50kHz=20 μs. This means that for a user velocity of 3 km/h, subcarrier allocation should be performed every 1800 symbols. This number of symbols is comparable to a typical number of symbols in a radio frame. The allocation of subcarriers may be done therefore, for example, once in a frame. For users moving at significantly higher velocities, it may be advisable to allocate subcarriers at a pace, which is slower than that defined by the coherence time.

It is appreciated that the pace for subcarrier allocation may be affected by the scheduling algorithms, which are used to ensure that data from each user will be sent within a reasonable time period.

Although the simulations described above where carried out by assuming fixed bit loading and power allocation, the performance of a multicarrier modulation system is even further enhanced, when adaptive modulation, bit loading and power allocation is used. Adaptive bit loading refers here, for example, to a system, where a plurality of modulation alphabets with varying number of bits per symbol can be used. Since certain modulation alphabets are better suited for different channel conditions the modulation to be used can be determined based on the channel conditions, and can for example be varied from one subcarrier to another. Also the transmit power allocated to the subcarriers, the channel coding and/or coding rate, and in multiple antenna systems the space-time/space-frequency modulation type can be varied based on the channel quality.

A multicarrier modulation communications device for embodiments of the present invention is configured to transmit at least one signal relating to at least one set of sequential subcarriers among a plurality of sets of sequential subcarriers allocated to a plurality of users in an allocation period. A multicarrier modulation communications device may be configured to transmit signals to a plurality of users in an allocation period. Alternatively, a multicarrier modulation communications device may be configured to transmit at least one signal relating to at least one set of sequential subcarriers among a plurality of sets of sequential subcarriers allocated to a plurality of users for transmission purposes.

A multicarrier modulation communications device typically comprises a controller, which is arranged accordingly to control the multicarrier modulation transmission. FIG. 1 shows a controller 111 in the transmitting device 110, and FIG. 2 shows a controller 212 in the MIMO transmitting device 210. A transceiver network element for a multicarrier modulation communication system or a control network element for a multicarrier modulation communication system is typically also configured to allocate the plurality of sets. As the allocation is typically performed based on channel quality information, the multicarrier modulation communications device, transceiver network element or a control network element may also be configured to obtain channel quality information. The channel quality information can be obtained as feedback information, or the channel quality information may be determined locally in the multicarrier modulation communications device, transceiver network element or in a control network element based on signals received from the users. For implementing embodiments of the invention, a controller 131 in a control network element 130 is arranged to perform in a suitable manner.

For the embodiments of the invention, a controller in a multicarrier modulation communications device or a multicarrier modulation communications devices may be configured to receive at least one signal relating to at least one set of sequential subcarriers among a plurality of sets of sequential subcarriers allocated to a plurality of users in an allocation period.

The multicarrier modulation communication device may be configured to receive at least one signal relating to at least one set of sequential subcarriers allocated to a user corresponding to the device from a signal relating to a plurality of sets of sequential subcarriers allocated to a plurality of users in an allocation period. Alternatively, a multicarrier modulation communications device or a controller in such a device may be configured to receive signals from a plurality of users using a plurality of sets of sequential subcarriers allocated to the plurality of users in an allocation period. FIG. 1 shows controllers 121 in user equipment devices 121, and FIG. 2 shows controllers 222 in receiving devices 220.

It is appreciated that only part of a multicarrier modulation bandwidth or the whole multicarrier modulation bandwidth may be allocated in sets of sequential subcarriers. If only part of the multicarrier modulation bandwidth is allocated in sets of sequential subcarriers, subcarriers within the rest of the multicarrier modulation bandwidth may be allocated using any other allocation method.

It is also appreciated that subcarrier may be allocated using sets of sequential subcarriers only in part of the allocation periods in a multicarrier modulation system or in a multicarrier modulation communications device. It is furthermore appreciated that the allocation of subcarriers in sets of sequential subcarriers to a plurality of users is envisaged to take place for an allocation period, so that in at least one allocation period there is at least a first set of sequential subcarriers allocated to a first user and a second set of sequential subcarriers allocated to a second user. The allocation may occur as one operation whose outcome is the allocation of sets of sequential subcarriers for an allocation period. It is possible that for a next allocation period the allocation of some sets of sequential subcarriers does not change, whereas other sets of sequential subcarriers may be allocated to different users than in a previous allocation period.

It is appreciated that the allocation of subcarriers in sets of sequential subcarriers is applicable with any channel code or modulation. The channel coding and modulation may be fixed or adaptive, and may include methods like space-time or space-frequency coding and modulation. Furthermore, any multiuser scheduling algorithm may be used in connection with allocation subcarriers in sets of sequential subcarriers. Any other resource allocation method, for example adaptive bit and power allocation, is also applicable with the present invention.

It is appreciated that the present invention is applicable to any multicarrier modulation communication system or device.

It is furthermore appreciated that term user in this description and in the appended claims refers to a receiving device or to a transmitting device. Term user is intended to cover any receiving/transmitting devices, for example user equipment, mobile telephones, mobile stations, personal digital assistants, laptop computers and the like and receivers/transmitters in a communication systems other than those directly used by human users. Term user may thus refer also to a transmitting/receiving network element of a multicarrier modulation system.

It is appreciated that term multicarrier modulation communication system refers to a system comprising at least one transmitting device and a plurality of receiving devices and/or to a system comprising at least one receiving device and a plurality of transmitting devices. At least some signals are transmitted using multicarrier modulation. Similarly, a multicarrier modulation device refers to a device capable of transmitting and receiving, respectively, multicarrier modulation signals. The multicarrier modulation device may be capable of transmitting and receiving also signals employing other modulation scheme. Typically a device, for example a base station or user equipment for a cellular telecommunications system, may transmit and receive multicarrier modulation signals.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method of allocating subcarriers in a multicarrier modulation communication system, the method comprising:
allocating a plurality of sets of sequential subcarriers to a plurality of users.

2. A method as defined in claim 1, further comprising:
determining a size of a set of sequential subcarriers.

3. A method as defined in claim 2, wherein said determining the size of a set of sequential subcarriers comprises taking into account a channel coherence bandwidth of at least one of the users.

4. A method as defined in claim 3, wherein said determining the size of the set of sequential subcarriers comprises taking into account a smallest channel coherence bandwidth of the plurality of users.

5. A method as defined in claim 3, wherein said determining the size of the set of sequential subcarriers comprises taking into account a channel coherence bandwidth of a respective user.

6. A method as defined in claim 2, wherein said determining the size of the set of sequential subcarriers comprises taking into account a modulation scheme of at least one of the plurality of users.

7. A method as defined in claim 2, wherein said determining the size of the set of sequential subcarriers comprises taking into account a coding scheme of at least one of the plurality of users.

8. A method as defined in claim 2, wherein said determining the size of the set of sequential subcarriers comprises providing a lower limit for the size of the set of sequential subcarriers.

9. A method as defined in claim 8, further comprising:
providing the lower limit comprising a cell-specific lower limit or a system specific lower limit.

10. A method as defined in claim 8, further comprising:
providing the lower limit comprising a system-specific lower limit; and
providing a further cell-specific lower limit for the size of the set of sequential subcarriers.

11. A method as defined in claim 2, wherein determining the size of the set of sequential subcarriers comprises selecting the size of the set of sequential subcarriers from a plurality of predetermined sizes.

12. A method as defined in claim 11, further comprising:
providing the size of the set of sequential subcarriers comprising a power of two.

13. A method as defined in claim 11, wherein said determining the size of the set of sequential subcarriers comprises taking into account a block length of a space-frequency code used for at least one of the plurality of users.

14. A method as defined in claim 11, further comprising:
providing a length of a coding block for at least one of the plurality of users comprising a multiple of the size of the set of sequential subcarriers.

15. A method as defined in claim 2, wherein said determining the size of the set of subcarriers comprises determining within an allocation period sets of sequential subcarriers having a same size.

16. A method as defined in claim 2, wherein said determining the size of the set of subcarriers comprises determining a first set of sequential subcarriers having a first size and a second set of sequential subcarriers having a second size within an allocation period.

17. A method as defined in claim 1, further comprising:
providing at least one unallocated guard band between two of the plurality of sets of sequential subcarriers allocated to the plurality of users.

18. A method as defined in claim 1, wherein said allocating the plurality of sets of sequential subcarriers comprises taking into account channel properties of at least one user.

19. A method as defined in claim 1, wherein said allocating the plurality of sets of sequential subcarriers comprises allocating to the plurality of users for transmitting information to the plurality of users.

20. A method as defined in claim 1, wherein said allocating the plurality of sets of sequential subcarrriers comprises allocating to the plurality of users for transmitting information from the plurality of users.

21. A network element for controlling multicarrier modulation communications, the network element being configured to allocate a plurality of sets of sequential subcarriers to a plurality of users in an allocation period.

22. A network element as defined in claim 21, wherein the network element is for a cellular telecommunications network.

23. A multicarrier modulation communication system, the multicarrier modulation communication system being configured to allocate a plurality of sets of sequential subcarriers to a plurality of users in an allocation period.

24. A method of multicarrier modulation transmission, the method comprising:
transmitting at least one signal relating to at least one set of sequential subcarriers among a plurality of sets of sequential subcarriers allocated in an allocation period to a plurality of users.

25. A method as defined in claim 24, further comprising:
allocating the plurality of sets of sequential subcarriers for transmitting information to the plurality of users.

26. A method as defined in claim 25, further comprising:
transmitting a plurality of signals to the plurality of users.

27. A method as defined in claim 24, further comprising:
allocating the plurality of sets of sequential subcarriers for transmitting information from the plurality of users.

28. A method of multicarrier modulation reception, the method comprising:
receiving at least one signal relating to at least one set of sequential subcarriers among a plurality of sets of sequential subcarriers allocated to a plurality of users in an allocation period.

29. A method as defined in claim 28, further comprising:
allocating the plurality of sets of sequential subcarriers for receiving information from the plurality of users.

30. A method as defined in claim 29, further comprising:
receiving a plurality of signals from the plurality of users.

31. A method as defined in claim 28, further comprising:
allocating the plurality of sets of sequential subcarriers for receiving information in the plurality of users.

32. A device for multicarrier modulation transmission, the device being configured to transmit at least one signal relating to at least one set of sequential subcarriers among a plurality of sets of sequential subcarriers allocated to the plurality of users in an allocation period.

33. A device as defined in claim 32, wherein the plurality of sets of sequential subcarriers is allocated for transmitting information to the plurality of users.

34. A device as defined in claim 32, wherein the plurality of sets of sequential subcarriers is allocated for transmitting information from the plurality of users, the device corresponding to at least one of the users.

35. A device for multicarrier modulation reception, the device being configured to receive at least one signal relating to at least one set of sequential subcarriers among a plurality of sets of sequential subcarriers allocated to a plurality of users in an allocation period.

36. A device as defined in claim 35, wherein the plurality of sets of sequential subcarriers is allocated for receiving information from the plurality of users.

37. A device as defined in claim 35, wherein the plurality of sets of sequential subcarriers is allocated for receiving information in the plurality of users, the device corresponding to at least one of the users.

38. A device as defined in claim 34, the device further configured to allocate the plurality of sets of sequential subcarriers.

39. A device as defined in claim 34, wherein the device is for a cellular telecommunications network.
